(19) United States
(12) Patent Application Publication
(10) Pub. No.: US 2026/0002433 A1
(43) Pub. Date: Jan. 1, 2026

(54) METHOD TO PREDICT SONIC LOG AT BIT IN REAL TIME

(71) Applicant: Halliburton Energy Services, Inc., Houston, TX (US)

(72) Inventors: Yonggui Guo, Houston, TX (US); Aidan James Porter, Aberdeen (GB)

(73) Assignee: Halliburton Energy Services, Inc., Houston, TX (US)

(21) Appl. No.: 18/754,534

(22) Filed: Jun. 26, 2024

(51) Int. Cl. E21B 44/00; E21B 45/00; E21B 47/085

(52) U.S. Cl. CPC E21B 44/00; E21B 45/00; E21B 47/085

(57) ABSTRACT

A method and/or system comprising disposing a logging tool into a borehole, wherein the logging tool comprises: a transmitter configured to transmit a sonic pulse into a borehole; and one or more receivers configured to detect reflected sonic pulses as measured sonic data. Further, the method and/or system may be further comprise forming a correlation between the measured sonic data and one measurement from the sonic data and the one or more drilling parameters; and predicting sonic data at a bit with the correlation and one or more drilling parameters. In addition to acoustics the method and/or system maya downhole transmitter configured to transmit a particle and/or wave into the borehole and observe a response from the particle and/or wave, wherein the response is a reflection of or an effect of the particle and/or wave within the borehole or within a formation surrounding the borehole.

### BACKGROUND

In order to obtain hydrocarbons such as oil and gas, boreholes are drilled through hydrocarbon-bearing subsurface formations. During drilling, logging tools may operate to determine the properties of formations surrounding the borehole with sonic or other downhole waves or particles. In measurement-while-drilling (MWD) or logging-wile-drilling (LWD) techniques, the testing equipment is conveyed down the borehole along with the drilling equipment. These tests may include resistivity testing equipment, gamma radiation testing equipment, seismic imaging equipment, sonic logging equipment, and/or the like.

During drilling operations, one or more LWD sonic logging tools may use guided-waves, such as dipole flexural, and quadrupole screw waves, to infer formation properties. Usually, the slownesses of these waves approach the formation body-wave slownesses at low frequencies. Thus, these waves are used to estimate formation slownesses and anisotropy.

Real-time geomechanics tools such as log software and analysis may utilize LWD logs. Log software may be performed in real-time using acoustic data LWD logs may comprise sonic and other acoustic for updating a geomechanical model before performing wellbore stability analysis. If the acoustic logging data is not available, other LWD data, such as resistivity may also be performed. LWD sensors however are installed about 100 ft behind bit. For this reason, the real-time geomechanic analysis tools update wellbore stability prediction about 100 fit behind bit rather than at bit. Any drilling events occurring close to or at bit therefore cannot be predicted in a timely manner by current analysis tools, which may significantly reduce the value of real-time geomechanics analysis as the geomechanics prediction is not in real time at bit. In addition, LWD log is not always available for real-time geomechanics analysis. Borehole collapse pressure predicted by real-time geomechanical model that is not updated with LWD log will not be different from one predicted by predrill geomechanical model.

### BRIEF DESCRIPTION OF THE DRAWINGS

These drawings illustrate certain aspects of some examples of the present disclosure and should not be used to limit or define the disclosure.

FIG. 1 illustrates an example of a drilling system;

FIG. 2 illustrates is a schematic view of an information handling system;

FIG. 3 illustrates another schematic view of and information handling system;

FIG. 4 illustrates a schematic view of a network;

FIG. 5 is a diagram of an example system with multiple information handling systems, connected via a network, and used to form computing resource pools;

FIG. 6 illustrates an example of a logging tool disposed in a borehole;

FIG. 7 is a workflow for predicting sonic log at the bit with a correlation between mechanical specific energy (MSE) and real-time sonic data to predict a sonic log at the bit; and

FIG. 8 illustrates workflow for predicting sonic log at the bit with a correlation between sonic/pseudo-sonic data from offset wells and MSE.

### DETAILED DESCRIPTION

Methods and systems described herein may be to determine correlations for finding sonic properties of formations at the drill bit. Acoustic wave fields in boreholes are often dominated by the fundamental modes. For example, the fundamental flexural and quadrupole modes often dominate the field generated by dipole and quadrupole sources, respectively. Formation elastic properties are typically estimated from these modes. However, when logging-while-drilling (LWD), the presence of a large tool mandrel may perturb the fundamental modes, particularly when the tool is partially or fully eccentric or the data is contaminated by tool body waves, resulting in erroneous formation slowness estimates.

Physically, to cut a rock, the drilling system must apply sufficient energy to overcome the strength of the rock under any giving confining pressure. More mechanical work is needed to remove the same volume of rock by the same bit if the rock is stronger. The mechanical work required to destroy a unit volume of rock is commonly quantified with mechanical specific energy (MSE) that can be expressed in terms of drilling parameters. Both experimental and numerical simulations have demonstrated that MSE under atmospheric pressure is approximately equal to the uniaxial compressive strength (UCS) of the rock. Drilling parameters have also been used to build the correlations between MSE and UCS for various rock types.

UCS not only correlates with MSE calculated from drilling parameters, but also shows a strong connection with sonic log (i.e., compressional wave velocity DTC). This is because the speed of compressional wave in rock is most significantly affected by rock porosity. The speed decreases with increasing rock porosity. Rock strength, on the other hand, is also significantly influenced by rock porosity. Rock strength decreases with increasing rock porosity. Thus, compressional wave travels faster in stronger rock. Since both MSE and compressional wave velocity are correlated with UCS, they are also correlated with each other. The correlation between MSE and compressional wave velocity for any borehole section can be built with drilling parameters and LWD sonic log from either target well or offset wells. The correlation can be also established using pseudo-sonic, such as sonic derived from resistivity. As drilling parameters are always available at any given borehole depth, the correlation can then be used to predict sonic log at depth where LWD logs are not available, such as at bit depth.

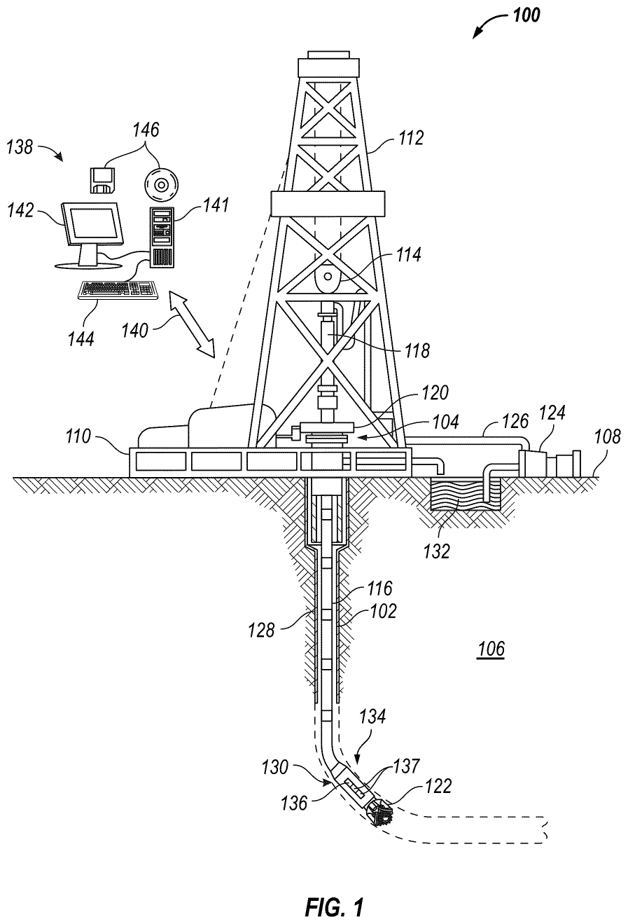

FIG. 1 illustrates a drilling system 100 in accordance with example embodiments. As illustrated, borehole 102 may extend from a wellhead 104 into a subterranean formation 106 from a surface 108. Generally, borehole 102 may include horizontal, vertical, slanted, curved, and other types of borehole geometries and orientations. Borehole 102 may be cased or uncased. In examples, borehole 102 may include a metallic member. By way of example, the metallic member may be a casing, liner, tubing, or other elongated steel tubular disposed in borehole 102.

As illustrated, borehole 102 may extend through subterranean formation 106. As illustrated in FIG. 1, borehole 102 may extend generally vertically into the subterranean formation 106, however borehole 102 may extend at an angle through subterranean formation 106, such as horizontal and slanted boreholes. For example, although FIG. 1 illustrates a vertical or low inclination angle well, high inclination angle or horizontal placement of the well and equipment may be possible. It should further be noted that while FIG. 1 generally depicts land-based operations, those skilled in the art may recognize that the principles described herein are equally applicable to subsea operations that employ floating or sea-based platforms and rigs, without departing from the scope of the disclosure.

As illustrated, a drilling platform 110 may support a derrick 112 having a traveling block 114 for raising and lowering drill string 116. Drill string 116 may include, but is not limited to, drill pipe and coiled tubing, as generally known to those skilled in the art. A kelly 118 may support drill string 116 as it may be lowered through a rotary table 120. A drill bit 122 may be attached to the distal end of drill string 116 and may be driven either by a downhole motor and/or via rotation of drill string 116 from surface 108. Without limitation, drill bit 122 may include roller cone bits, PDC bits, natural diamond bits, any hole openers, reamers, coring bits, and the like. As drill bit 122 rotates, it may create and extend borehole 102 that penetrates various subterranean formations 106. A pump 124 may circulate drilling fluid through a feed pipe 126 through kelly 118, downhole through interior of drill string 116, through orifices in drill bit 122, back to surface 108 via annulus 128 surrounding drill string 116, and into a retention pit 132.

With continued reference to FIG. 1, drill string 116 may begin at wellhead 104 and may traverse borehole 102. Drill bit 122 may be attached to a distal end of drill string 116 and may be driven, for example, either by a downhole motor and/or via rotation of drill string 116 from surface 108. Drill bit 122 may be a part of bottom hole assembly (BHA) 130 at distal end of drill string 116. BHA 130 may further include tools for look-ahead resistivity applications. As will be appreciated by those of ordinary skill in the art, BHA 130 may be a measurement-while-drilling (MWD) or logging-while-drilling (LWD) system.

BHA 130 may comprise any number of tools, transmitters, and/or receivers to perform downhole measurement operations. For example, as illustrated in FIG. 1, BHA 130 may include a logging tool 134. It should be noted that logging tool 134 may make up at least a part of BHA 130. Without limitation, any number of different measurement assemblies, communication assemblies, battery assemblies, and/or the like may form BHA 130 with logging tool 134. Additionally, logging tool 134 may form BHA 130 itself. In examples, logging tool 134 may comprise a transmitter 136. Transmitter 136 may be connected to information handling system 138, discussed below, which may further control the operation of transmitter 136. Transmitter 136 may include any suitable transmitter for generating sound waves that travel into formation 106, including, but not limited to, piezoelectric transmitters. Transmitter 136 may be a monopole source, a multi-pole source (e.g., a dipole source, quadrupole source, hexapole source, unipole source), high-order multipole, or any combination of multiple sources. Combinations of different types of transmitters may also be used. During operations, transmitter 136 may broadcast sound waves (e.g., sonic waveforms) from logging tool 134 that travel into formation 106. The sound waves may be emitted at any suitable frequency range. For example, a broadband response may be from about 0.2 kHz to about 20 kHz, and a narrow band response may be from about 1 kHz to about 6 kHz. It should be understood that the present technique should not be limited to these frequency ranges. Rather, the sound waves may be emitted at any suitable frequency for a particular application.

Logging tool 134 may also include a receiver 137. As illustrated, there may be a plurality of receivers 137 disposed on logging tool 134. Receiver 137 may include any suitable receiver for receiving sound waves, including, but not limited to, piezoelectric receivers. For example, receiver 137 may be a monopole receiver, a unipole receiver, or multi-pole receiver (e.g., a dipole receiver). In examples, a monopole receiver 137 may be used to record compressional-wave (P-wave) signals, while the multi-pole receiver 137 may be used to record shear-wave (S-wave) signals. Receiver 137 may have the function of recording dipole signals from two directions that are perpendicular to each other. Receiver 137 may also have the function of recording quadrupole signals from two directions that are 45 degrees apart. In examples, signals recorded by receiver 137 may be digitally created by information handling system 138 in any direction to simulate dipole and quadrupoles measurements. Receiver 137 may measure and/or record sound waves broadcast from transmitter 136 as received signals. The sound waves received at receiver 137 may include both direct waves that traveled along the borehole 102 and refract through formation 106 as well as waves that traveled through formation 106 and reflect off of near borehole bedding and propagate back to the borehole. By way of example, the received signal may be recorded as an acoustic amplitude as a function of time. Information handling system 138 may control the operation of receiver 137. The measured sound waves may be transferred to information handling system 138 for further processing. In examples, there may be any suitable number of transmitters 136 and/or receivers 137, which may be controlled by information handling system 138. Information and/or measurements may be processed further by information handling system 138 to determine properties of borehole 102, fluids, and/or formation 106.

Without limitation, BHA 130 may be connected to and/or controlled by information handling system 138, which may be disposed on surface 108. Without limitation, information handling system 138 may be disposed downhole in BHA 130. Processing of information recorded may occur downhole and/or on surface 108. Processing occurring downhole may be transmitted to surface 108 to be recorded, observed, and/or further analyzed. Additionally, information recorded on information handling system 138 that may be disposed downhole may be stored until BHA 130 may be brought to surface 108. In examples, information handling system 138 may communicate with BHA 130 through a communication line (not illustrated) disposed in (or on) drill string 116. In examples, wireless communication may be used to transmit information back and forth between information handling system 138 and BHA 130. Information handling system 138 may transmit information to BHA 130 and may receive as well as process information recorded by BHA 130. In examples, a downhole information handling system (not illustrated) may include, without limitation, a microprocessor or other suitable circuitry, for estimating, receiving and processing signals from BHA 130. Downhole information handling system (not illustrated) may further include additional components, such as memory, input/output devices, interfaces, and the like. In examples, while not illustrated, BHA 130 may include one or more additional components, such as analog-to-digital converter, filter and amplifier, among others, which may be used to process the measurements of BHA 130 before they may be transmitted to surface 108. Alternatively, raw measurements from BHA 130 may be transmitted to surface 108.

Any suitable technique may be used for transmitting signals from BHA 130 to surface 108, including, but not limited to, wired pipe telemetry, mud-pulse telemetry, acoustic telemetry, and electromagnetic telemetry. While not illustrated, BHA 130 may include a telemetry subassembly that may transmit telemetry data to surface 108. At surface 108, pressure transducers (not shown) may convert the pressure signal into electrical signals for a digitizer (not illustrated). The digitizer may supply a digital form of the telemetry signals to information handling system 138 via a communication link 140, which may be a wired or wireless link. The telemetry data may be analyzed and processed by information handling system 138.

As illustrated, communication link 140 (which may be wired or wireless, for example) may be provided that may transmit data from BHA 130 to an information handling system 138 at surface 108. Information handling system 138 may include a personal computer 141, a video display 142, an input device 144 (i.e., other input devices), and/or non-transitory computer-readable media 146 (e.g., optical disks, magnetic disks) that can store code representative of the methods described herein. In addition to, or in place of processing at surface 108, processing may occur downhole. Information handling system 138 may direct one or more transmitters 136 to operate and/or function. Likewise, information handling system 138 may process measurements taken by one or more receivers 137. As discussed below, transmitters 136 and receivers 137 may include a unipole with a single element, an LWD monopole with four elements, or an LWD dipole with two elements.

Information handling system 138 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 138 may be a personal computer, a network storage device, or any other suitable device and may vary in size, shape, performance, functionality, and price. Information handling system 138 may include random access memory (RAM), one or more processing resources such as a central processing unit (CPU) or hardware or software control logic, ROM, and/or other types of nonvolatile memory. Additional components of the information handling system 138 may include one or more disk drives 146, video displays 142, such as a video display, and one or more network ports for communication with external devices as well as an input device 144 (e.g., keyboard, mouse, etc.). Information handling system 138 may also include one or more buses operable to transmit communications between the various hardware components.

Alternatively, systems and methods of the present disclosure may be implemented, at least in part, with non-transitory computer-readable media. Non-transitory computer-readable media may include any instrumentality or aggregation of instrumentalities that may retain data and/or instructions for a period of time. Non-transitory computer-readable media may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

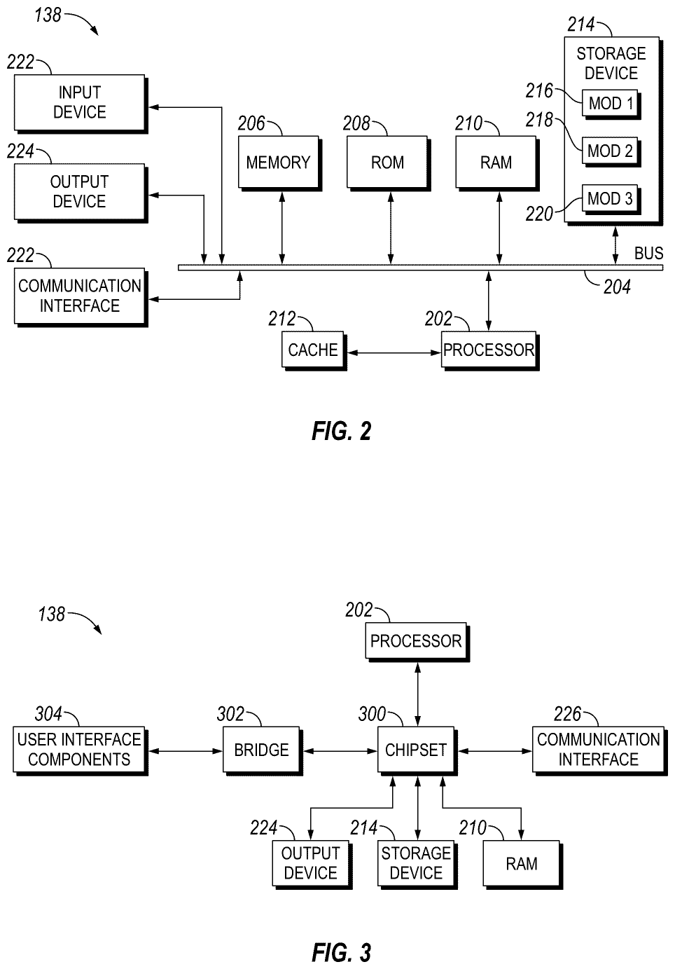

FIG. 2 illustrates an example information handling system 138 which may be employed to perform various steps, methods, and techniques disclosed herein. Persons of ordinary skill in the art will readily appreciate that other system examples are possible. As illustrated, information handling system 138 includes a processing unit (CPU or processor) 202 and a system bus 204 that couples various system components including system memory 206 such as read only memory (ROM) 208 and random-access memory (RAM) 210 to processor 202. Processors disclosed herein may all be forms of this processor 202. Information handling system 138 may include a cache 212 of high-speed memory connected directly with, in close proximity to, or integrated as part of processor 202. Information handling system 138 copies data from memory 206 and/or storage device 214 to cache 212 for quick access by processor 202. In this way, cache 212 provides a performance boost that avoids processor 202 delays while waiting for data. These and other modules may control or be configured to control processor 202 to perform various operations or actions. Another system memory 206 may be available for use as well. Memory 206 may include multiple different types of memory with different performance characteristics. It may be appreciated that the disclosure may operate on information handling system 138 with more than one processor 202 or on a group or cluster of computing devices networked together to provide greater processing capability. Processor 202 may include any general-purpose processor and a hardware module or software module, such as first module 216, second module 218, and third module 220 stored in storage device 214, configured to control processor 202 as well as a special-purpose processor where software instructions are incorporated into processor 202. Processor 202 may be a self-contained computing system, containing multiple cores or processors, a bus, memory controller, cache, etc. A multi-core processor may be symmetric or asymmetric. Processor 202 may include multiple processors, such as a system having multiple physically separate processors in different sockets, or a system having multiple processor cores on a single physical chip. Similarly, processor 202 may include multiple distributed processors located in multiple separate computing devices but working together such as via a communications network. Multiple processors or processor cores may share resources such as memory 206 or cache 212 or may operate using independent resources. Processor 202 may include one or more state machines, an application specific integrated circuit (ASIC), or a programmable gate array (PGA) including a field PGA (FPGA).

Each individual component discussed above may be coupled to system bus 204, which may connect each and every individual component to each other. System bus 204 may be any of several types of bus structures including a memory bus or memory controller, a peripheral bus, and a local bus using any of a variety of bus architectures. A basic input/output (BIOS) stored in ROM 208 or the like, may provide the basic routine that helps to transfer information between elements within information handling system 138, such as during start-up. Information handling system 138 further includes storage devices 214 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 214 may include software modules 216, 218, and 220 for controlling processor 202. Information handling system 138 may include other hardware or software modules. Storage device 214 is connected to the system bus 204 by a drive interface. The drives and the associated computer-readable storage devices provide nonvolatile storage of computer-readable instructions, data structures, program modules and other data for information handling system 138. In one aspect, a hardware module that performs a particular function includes the software component stored in a tangible computer-readable storage device in connection with the necessary hardware components, such as processor 202, system bus 204, and so forth, to carry out a particular function. In another aspect, the system may use a processor and computer-readable storage device to store instructions which, when executed by the processor, cause the processor to perform operations, a method or other specific actions. For example, the hybrid data generator, which may include a Large Language Model or other models derived from machine learning- and deep learning algorithms, may include computational instructions which may be executed on a processor to generate an initial and/or an updated drilling program. In some examples, the deep learning algorithms may include convolutional neural networks, long short term memory networks, recurrent neural networks, generative adversarial networks, attention neural networks, zero-shot models, fine-tuned models, domain-specific models, multi-modal models, transformer architectures, radial basis function networks, multilayer perceptrons, self-organizing maps, deep belief networks, and combinations thereof. The basic components and appropriate variations may be modified depending on the type of device, such as whether information handling system 138 is a small, handheld computing device, a desktop computer, or a computer server. When processor 202 executes instructions to perform “operations”, processor 202 may perform the operations directly and/or facilitate, direct, or cooperate with another device or component to perform the operations.

As illustrated, information handling system 138 employs storage device 214, which may be a hard disk or other types of computer-readable storage devices which may store data that are accessible by a computer, such as magnetic cassettes, flash memory cards, digital versatile disks (DVDs), cartridges, random access memories (RAMs) 210, read only memory (ROM) 208, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 138, an input device 222 represents any number of input mechanisms, such as a microphone for speech, a touch-sensitive screen for gesture or graphical input, keyboard, mouse, motion input, speech and so forth. An output device 224 may also be one or more of a number of output mechanisms known to those of skill in the art. In some instances, multimodal systems enable a user to provide multiple types of input to communicate with information handling system 138. Communications interface 226 generally governs and manages the user input and system output. There is no restriction on operating on any particular hardware arrangement and therefore the basic hardware depicted may easily be substituted for improved hardware or firmware arrangements as they are developed.

As illustrated, each individual component described above is depicted and disclosed as individual functional blocks. The functions these blocks represent may be provided through the use of either shared or dedicated hardware, including, but not limited to, hardware capable of executing software and hardware, such as a processor 202, that is purpose-built to operate as an equivalent to software executing on a general-purpose processor. For example, the functions of one or more processors presented in FIG. 2 may be provided by a single shared processor or multiple processors. (Use of the term “processor” should not be construed to refer exclusively to hardware capable of executing software.) Illustrative examples may include microprocessor and/or digital signal processor (DSP) hardware, read-only memory (ROM) 208 for storing software performing the operations described below, and random-access memory (RAM) 210 for storing results. Very large-scale integration (VLSI) hardware examples, as well as custom VLSI circuitry in combination with a general-purpose DSP circuit, may also be provided.

FIG. 3 illustrates an example information handling system 138 having a chipset architecture that may be used in executing the described method and generating and displaying a graphical user interface (GUI). Information handling system 138 is an example of computer hardware, software, and firmware that may be used to implement the disclosed technology. Information handling system 138 may include a processor 202, representative of any number of physically and/or logically distinct resources capable of executing software, firmware, and hardware configured to perform identified computations. Processor 202 may communicate with a chipset 300 that may control input to and output from processor 202. In this example, chipset 300 outputs information to output device 224, such as a display, and may read and write information to storage device 214, which may include, for example, magnetic media, and solid-state media. Chipset 300 may also read data from and write data to RAM 210. Bridge 302 for interfacing with a variety of user interface components 304 may be provided for interfacing with chipset 300. User interface components 304 may include a keyboard, a microphone, touch detection and processing circuitry, a pointing device, such as a mouse, and so on. In general, inputs to information handling system 138 may come from any of a variety of sources including machine generated and/or human generated.

Chipset 300 may also interface with one or more communication interfaces 226 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 202 analyzing data stored in storage device 214 or RAM 210. Further, information handling system 138 may receive one or more inputs from a user via user interface components 304 and execute appropriate functions, such as browsing functions by interpreting these inputs using processor 202.

In examples, information handling system 138 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

During drilling operations, information handling system 138 may process different types of real time data originated from varied sampling rates and various sources, such as diagnostics data, sensor measurements, operations data, and/or the like. These one or more measurements from borehole 102, BHA 130, logging tool 134, and one or more transmitters 136 may allow for information handling system 138 to perform real-time health assessment of the drilling operation. In some examples, the foregoing one or more measurements may be utilized to generate an updated drilling program when the one or more measurements are supplied to the hybrid data generator. Drilling tools and equipment may further comprise a variety of sensors which may be able to provide one or more real-time measurements and data relevant to steering the wellbore in adherence to a well plan. In some examples this drilling equipment may include drilling rigs, top drives, drilling tubulars, mud motors, gyroscopes, accelerometers, magnetometers, bent housing subs, directional steering heads, rotary steerable systems (“RSS”), whipstocks, push-the-bit systems, point-the-bit systems, and other directional drilling tools. In the context of drilling operations, “real-time,” may be construed as monitoring, gathering, assessing, and/or utilizing data contemporaneously with the execution of the drilling operation. Real-time operations may further comprise modifying the initial design or execution of the planned operation in order to modify a well plan of a drilling operation. In some examples, the modifications to the drilling operation may occur through automated or semi-automated processes. An example of an automated drilling process may include relaying or downlinking a set of operational commands (control commands) to an RSS in order to modify a drilling operation to achieve a certain objective. In other examples, operational commands (control commands), which may be derived from an initial or an updated drilling program may be automatically relayed to the top drive. In other examples, the operational commands (control commands) may be relayed to the rig personnel for review prior to implementation. In some examples, one or more drilling objectives and operational features may be incorporated into the drilling operation through the utilization of a cost function. In further examples, the cost function may be optimized for one or more operational features including but not limited to maximizing rate of penetration, maximizing hole cleaning, maximizing hole stability, operational safety, minimizing total drilling cost, minimizing operational time per hole section, minimizing cost per hole section, and combinations thereof.

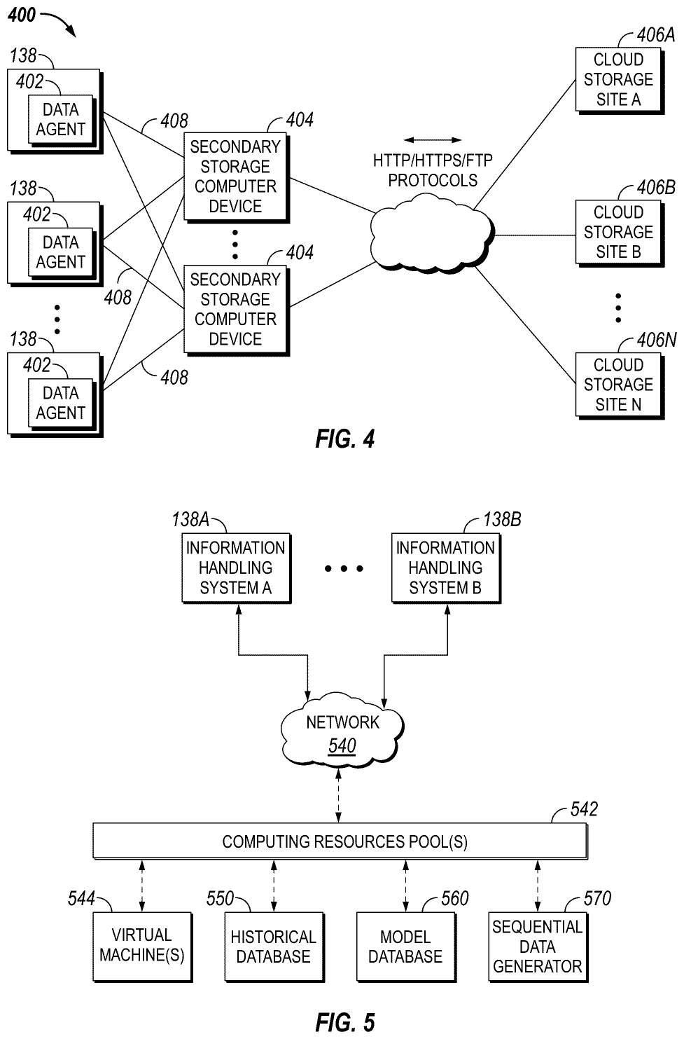

FIG. 4 illustrates an example of one arrangement of resources in a computing network 400 that may employ the processes and techniques described herein, although many others are of course possible. As noted above, an information handling system 138, as part of their function, may utilize data, which includes files, directories, metadata (e.g., access control list (ACLS) creation/edit dates associated with the data, etc.), and other data objects. The data on the information handling system 138 is typically a primary copy (e.g., a production copy). During a copy, backup, archive or other storage operation, information handling system 138 may send a copy of some data objects (or some components thereof) to a secondary storage computing device 404 by utilizing one or more data agents 402.

A data agent 402 may be a desktop application, website application, or any software-based application that is run on information handling system 138. As illustrated, information handling system 138 may be disposed at any rig site (e.g., referring to FIG. 1) or repair and manufacturing center. The data agent may communicate with a secondary storage computing device 404 using communication protocol 408 in a wired or wireless system. The communication protocol 408 may function and operate as an input to a website application. In the website application, field data related to pre- and post-operations, generated DTCs, notes, and the like may be uploaded. Additionally, information handling system 138 may utilize communication protocol 408 to access processed measurements, operations with similar DTCs, troubleshooting findings, historical run data, and/or the like. This information is accessed from secondary storage computing device 404 by data agent 402, which is loaded on information handling system 138.

Secondary storage computing device 404 may operate and function to create secondary copies of primary data objects (or some components thereof) in various cloud storage sites 406A-N. Additionally, secondary storage computing device 404 may run determinative algorithms on data uploaded from one or more information handling systems 138, discussed further below. Communications between the secondary storage computing devices 404 and cloud storage sites 406A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 406A-N, the secondary storage computing device 404 may also perform local content indexing and/or local object-level, sub-object-level or block-level deduplication when performing storage operations involving various cloud storage sites 406A-N. Cloud storage sites 406A-N may further record and maintain DTC code logs for each downhole operation or run, map DTC codes, store repair and maintenance data, store operational data, and/or provide outputs from determinative algorithms and or models that are located in cloud storage sites 406A-N. In a non-limiting example, this type of network may be utilized as a platform to store, backup, analyze, import, and perform extract, transform and load (“ETL”) processes to the data gathered during a drilling operation. In further examples, this type of network may be utilized to execute a hybrid data generator to generate an initial and/or an updated drilling program.

As previously mentioned, the hybrid data generator may include a stack of models which are run in series, in parallel, or combinations thereof to produce a drilling program. The development of drilling programs, whether executed using a hybrid data generator or using traditional methods, may require the analysis of text-based data. Additionally, the drilling programs (e.g., an output from a hybrid data generator) themselves may include text-based data. In some examples, Large Language Models may be proficient in analyzing input provided in the form of text, while providing an output in the form of text. As such, a Large Language Model may be included in the stack of models which form the hybrid data generator. In some examples, Large Language Models may be trained on large amounts of text data including but not limited to books, technical papers, articles, previous drilling reports, web-based content, emails, technical presentations, and various other forms of text-based data. In some examples, a Large Language Model algorithm may include a deep learning architecture which may be referred to as a transformer architecture. The transformer architecture may allow for a language model to perform natural language processing tasks in a fashion that mimics human-like responses. In some examples, tasks performed by natural language processing may include text-based content creation and generation, next-word predictions in sentence construction, summarization, machine translation, application (e.g., computer-based “apps”) generation, and/or answering text-based questions with text-based responses. In further examples, large language models supported by transformer architecture may be able to learn the patterns and structures of language.

FIG. 5 is a diagram of an example system with multiple information handling systems, connected via a network, and used to form computing resource pools. While a specific configuration may be shown, other configurations may be used without departing from the disclosed embodiment. Accordingly, embodiments disclosed herein should not be limited to the configuration of devices and/or components shown.

In any embodiment, a system may include one or more information handling system(s) (e.g., information handling system A 200A, information handling system B 200B), network 540, computing resource pool(s) 542, virtual machine(s) 544, historical database 550, model database 560, and sequential data generator 570. Each of these components is described below.

Network 540 may be a collection of connected network devices (not shown) that allow for the communication of data from one network device to other network devices, or the sharing of resources among network devices. Non-limiting examples of network 540 include a local area network (LAN), a wide area network (WAN) (e.g., the Internet), a mobile network, any combination thereof, or any other type of network that allows for the communication of data and sharing of resources among network devices and/or information handling systems 200 operatively connected to network 540. One of ordinary skill in the art, having the benefit of this detailed description, would appreciate that a network may be a collection of operatively connected computing devices that enables communication between those computing devices.

Computing resource pool(s) 542 are organized clusters of virtualized resources of the components, or subcomponents, of one or more information handling systems 200. Non-limiting examples of a computing resource include processor(s) 202, a processor thread, any range of memory 206, any blocks on storage device(s) 214, input device(s) 222, output device(s) 224, communication interface(s) 226, and any peripheral device components of sub-components thereof (e.g., a graphics processing unit (GPU), data processing unit (DPU), NIC, etc.). An orchestrator (not shown) may track, monitor, aggregate, computing resources together and present those resources as a “pool” of computing resources (i.e., computing resources pool(s) 542) based on a shared property. As a non-limiting example, memory 206 disposed across six information handling systems 200 may be “pooled” together and presented as a single “memory pool” (in computing resource pool(s) 542). Similarly, as another non-limiting example, GPUs installed in three independent information handling systems 200 may be “pooled” into a single “GPU pool” (in computing resource pool(s) 542). As a third non-limiting example, storage device(s) 214 disposed within a single information handling system 200 may be presented as a “storage pool” (in computing resource pool(s) 542). In turn, the orchestrator may assign (e.g., allocate) portions of one or more computing resources pool(s) 542 to software (e.g., virtual machine(s) 544, sequential data generator 570) and virtual storage volume(s) (e.g., network attached storage (NAS), historical database 550, model database 560).

As used herein, “software” means any set of computer instructions, code, and/or algorithms that are used by information handling system 200 to perform one or more specific task(s), function(s), or process(es). Information handling system 200 may execute software by reading data from memory 206 and/or storage device(s) 214, processing that data via processor 202, and writing processed data to memory 206 and/or storage device(s) 214. Multiple software instances may execute on a single information handling system 200 simultaneously. Further, in any embodiment, a single software instance may utilize resources from two or more information handling systems 200 simultaneously (e.g., via computing resource pool(s) 542) and may move between information handling systems 200, as instructed (e.g., by an orchestrator).

A virtual storage volume (e.g., historical database 550, model database 560) may be a virtual space where data may be stored. A virtual storage volume may use any suitable means of underlying storage device(s) 214 and/or memory 206 for storing data (e.g., a storage pool and/or memory pool available in computing resource pool(s) 542). A virtual storage volume may be managed by a virtual machine 544 that handles the access (reads/writes), filesystem, redundancy, and addressability of the data stored therein.

Virtual machine 544 may be software, executing on one or more information handling system(s) 200, that provides a virtual environment in which other software (e.g., a program, a process, an application, etc.) may execute. In any embodiment, virtual machine 544 may be created by a virtual machine manager (e.g., a “hypervisor”) that allocates some portion of computing resources (e.g., in one or more computing resource pool(s) 542) for virtual machine 544 to execute. The computing resources allocated to virtual machine 544 may be aggregated from one or more information handling system(s) 200 and presented as unified “virtual” resources within virtual machine 544 (e.g., virtual processor(s), virtual memory, virtual storage, virtual peripheral device(s), etc.). As computing resource pool(s) 542 are used to generate virtual machine 544, the underlying hardware storing, executing, and processing the operations (of virtual machine 544) may disposed in any number of information handling system(s) 200.

In any embodiment, virtual machine 544 may be created specifically for using one or more computing resource pool(s) 542 related to machine learning, deep learning, and/or artificial intelligence (e.g., from one or more processor(s) 202). Such virtual machine 544 may allow for the “offline” private training of one or more data model(s) (e.g., in model database 560) without exposing data in historical database 550 to any third party.

Model database 560 may be a data structure (i.e., a collection of data) that includes information about previous drilling projects. Model database 560 may take the form of a virtual storage volume (e.g., using a “storage pool” of the computing resource pool(s) 542) and/or model database 560 may be data stored locally on a single information handling system 200 (e.g., as files in a directory). Sequential data generator 570 may be software, executing on one or more information handling system(s) 200 and/or in one or more virtual machine(s) 544, that processes input data to generate output data, using one or more data models.

Historical database 550 may be a data structure (i.e., a collection of data) that includes information about previous drilling projects. Historical database 550 may take the form of a virtual storage volume (e.g., using a “storage pool” of the computing resource pool(s) 542) and/or historical database 550 may be data stored locally on a single information handling system 200 (e.g., as files in a directory). Further, historical database 550 may comprise any information available to a geosteerer. Historical database 550 may be utilized in workflows below.

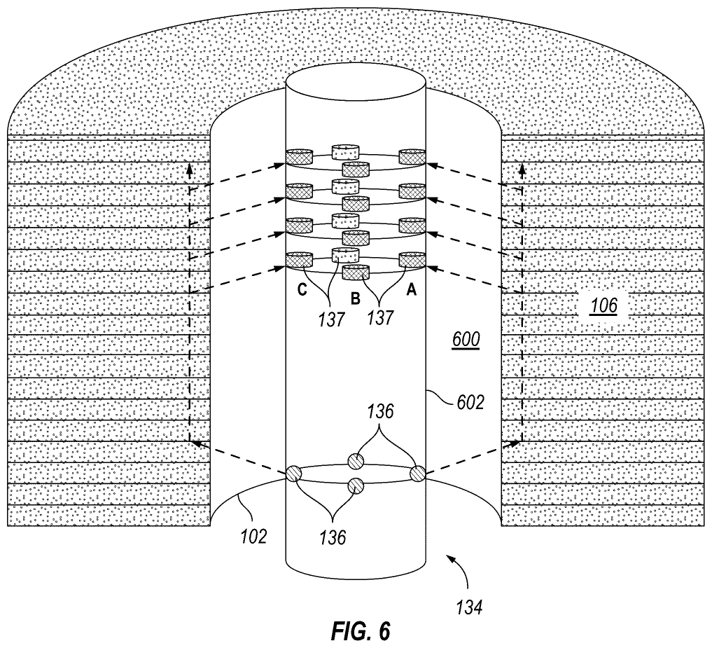

FIG. 6 illustrates logging tool 134 during drilling operations taking one or more measurements. As illustrated, logging tool 134 may be disposed in a borehole 102 that traverses through formation 106. In examples, borehole 102 may be filled with fluid 600. During measurement operations logging tool 134 may operate and function to record refracted compressional waves, refracted shear waves, and guided waves propagating along the borehole wall. Analysis of these waves yields the formation compressional and shear velocities. Logging tool 134 may utilize one or more transmitters 136 to broadcast acoustic waves into borehole 102. Additionally, one or more receivers 137, which may be disposed in one or more multi-sets of arrays, measures the waves inside borehole 102. In examples, transmitters 136 and receivers 137 may be placed azimuthally inside logging tool 134 and at a radial distance from an axis of logging tool 134 at/or near exterior surface of logging tool 134.

These measurements may be transmitted to information handling system 138 where the measurements may be transformed into data. The data may be processed to obtain formation slowness logs, graphs, and for further processing with mechanical specific energy (MSE), to be discussed below. The processing and transmission of measurements may be in real-time. Herein, real-time may be instantaneous, 0.001 ns-1 ns, 1 ns-0.001 s, 0.001 s-1 s, 1 s-1 m, or 1 m-1 h. In addition, continuously may be the same measurement, computation, or process occurring in real-time for a varied number of times. Further, transmitters 136 may be replaced with an electromagnetic transmitter and receivers 137 may be replaced with resistivity receivers 137. As such, logging tool 134 may also be configured to measure a resistivity log. In addition to resistivity, any other downhole measurement may be performed. This may comprise any acoustic measurements, electromagnetic measurements, induction measurements, nuclear magnetic resonance measurements, gamma measurements, or any physical or wave particle capable of creating a measurable reflection or effect observable by logging tool 134. Herein, logging tool 134 may also be referred to sonic logging tool 134.

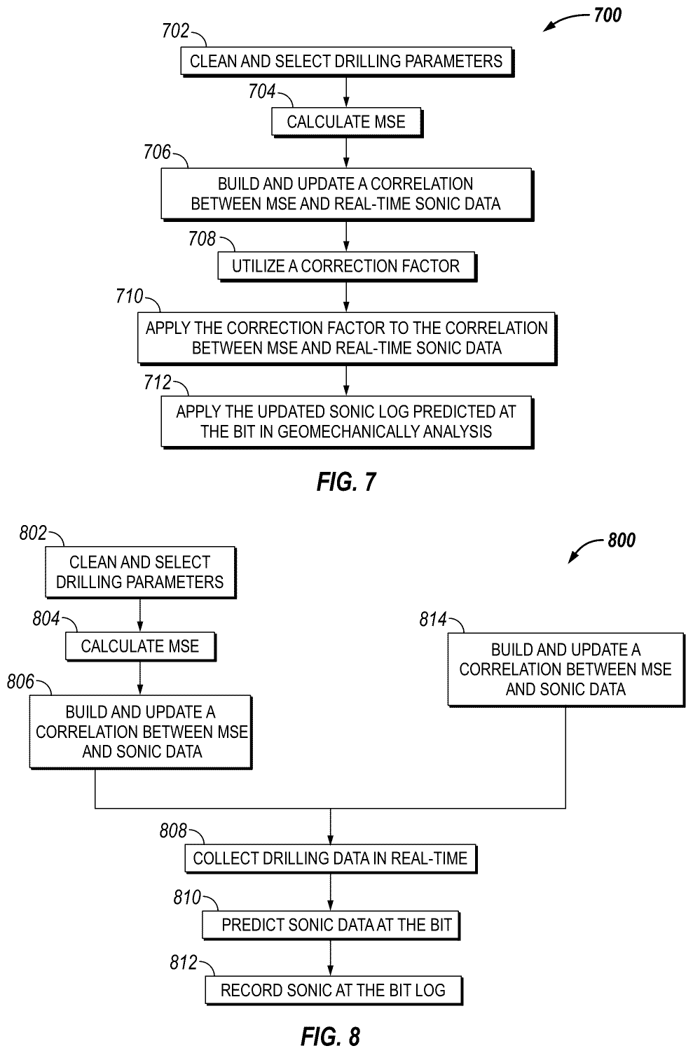

FIG. 7 is a workflow 700 for predicting sonic log at the bit with a correlation between mechanical specific energy (MSE) and real-time sonic data to predict a sonic log at the bit. In examples, workflow 700 may be performed on information handling system 138 (e.g., referring to FIG. 1). In block 702, drilling parameters may be cleaned and selected. For selecting drilling parameters, if they are measured at the bit, they are ideal for MSE calculations and correlations. This is because drilling parameters measured at surface, such as torque on bit is not only affected by rock strength, but also influenced by other factors, such as frictional interaction between drill pipe and wellbore. In case if drilling parameters at bit are not available, drilling parameters measured at surface can also be used to build the correlation. The correlation, however, may yield less reliable sonic prediction.

The drilling parameters collected may comprise WOB weight on bit, TOB torque on bit, RPM rotary per minute, ROP rate of penetration, and d bit diameter may be used to calculate mechanical specific energy (MSE), to be discussed in block 704. In examples, MSE may be updated as frequently as WOB, TOB, RPM, and ROP are updated. In examples, WOB, TOB, RPM and ROP are commonly measured and updated every second during drilling or in real-time. Thus, MSE may be updated every second or in real time. Referring back to block 702, any abnormal measurements of drilling parameters are not suitable for building the correlation, such as negative ROP/WOB and abnormally low WOB and RPM. These measurements must be removed and cleaned from drilling parameter data before the data is applied to calculate MSE.

In block 704, with the collected drilling parameters comprising WOB weight on bit, TOB torque on bit, RPM rotary per minute, ROP rate of penetration, and d bit diameter may be used to calculate mechanical specific energy (MSE) in Equation (1):

$$MSE = \frac{4 * WOB}{π * {d}^{2}} + \frac{480 * TOB * RPM}{{d}^{2} + ROP} \qquad ( 1 )$$

In block 706, a correlation between MSE and real-time sonic data may be built and updated. First, a correlation may be the variation of sonic data with MSE may be best fit with a power law in Equation (2):

$${S}_{p} = a * {MSE}^{b} \qquad ( 2 )$$

Herein a is a constant, b is a power exponent, and Sₚ is predicted sonic at the bit. In examples, constant a and power exponent b may be determined before Equation (2) is applied. To illustrate, predicted sonic at the bit Sₚ may be replaced with the actual measured sonic data from logging tool 134, above the bit. Then with a calculated MSE, constant a and power exponent b may be determined to best fit a correlation between MSE and the actual measured sonic data from logging tool 134. Once constant a and power exponent b are determined, Equation (2) may determine predicted sonic at the bit Sₚ with MSE and the best fit constant a and power exponent b. MSE may be constantly updated or provided in real time with updated drilling parameters to compute new predicted sonic at the bit Sₚ. In addition, constant a and power exponent b may also be constantly updated to provide more updated best fit components. The best fit for constant a and power exponent b may define a power law correlation between predicted sonic at the bit Sₚ and MSE. In other examples, the variation of sonic data with MSE may be best fit with a linear equation in Equation (3):

$${S}_{p} = m * MSE + n \qquad ( 3 )$$

Herein m is a slope and n is the y-intercept. Similar to the example above, the best fit for slope m and y-intercept n may be determined before Equation (3) computes predicted sonic at the bit Sₚ. Once m and y-intercept n are determined, Equation (3) may be applied with updated MSE to constantly produce a log of predicted sonic at the bit Sₚ. Further, any power law, linear, or any other possible correlation may be applied. The best fit for slope m and y-intercept n may define a linear correlation between predicted sonic at the bit Sₚ and MSE.

If computing power is too limited to establish more than one correlations and find the best one in real time, the correlation defined with power law equation will be used for sonic prediction as the variation of sonic with MSE can be well described with the power law in general. In addition, drilling parameters and sonic logs may be continuously measured and collected during a drilling operation in real-time. Thus, the correlation, either power law, linear, or another mathematical principle may also be updated in real time. If real-time sonic log is not available, a pseudo-sonic derived from other real-time log, such as density log or resistivity log, may be used to build the correction. This may comprise any acoustic measurements, electromagnetic measurements, induction measurements, nuclear magnetic resonance measurements, gamma measurements, or any physical or wave particle capable of creating a measurable reflection or effect observable by logging tool 134 (e.g., referring to FIG. 1).

The correlation between MSE and sonic may be improved, particularly when surface data is used to establish the correlation and/or there has not been enough data to build the correlation. In addition, the correlation may not predict sonic accurately within transitional zone between two adjacent formations if there is a strong rock strength contrast between these two formations. In addition, as discussed above measurements may be non-sonic measurements.

In block 708, a correction factor may be utilized to improve the accuracy of the sonic prediction and the correlation from block 706. Correction factor may be at least partially based on minimum deviation (minD) of predicted sonic from last n sonic measurements and may be determined in Equation (4):

$$m i n D = \{ \begin{matrix}Min ( {\{ \vert {S}_{mi} - {S}_{pi} \vert \}}_{i = 1}^{n} ) Min ( {\{ \vert {S}_{mi} - {S}_{pi} \vert \}}_{i = 1}^{n} ) = Min ( {\{ \vert {S}_{mi} - {S}_{pi} \vert \}}_{i = 1}^{n} ) \\ - Min ( {\{ \vert {S}_{mi} - {S}_{pi} \vert \}}_{i = 1}^{n} ) Min ( {\{ \vert {S}_{mi} - {S}_{pi} \vert \}}_{i = 1}^{n} ) \neq Min ( {\{ \vert {S}_{mi} - {S}_{pi} \vert \}}_{i = 1}^{n} )\end{matrix} \qquad ( 4 )$$

where Sₘᵢ is measured sonic and Sₚᵢ is predicted sonic by the correlation equation selected from block 706. The value of n is dependent on the number of sonic measurement available. Its maximum value is set to 10 balance between calculation efficiency and accuracy. As expressed in Equation (4), minD may be

$$Min ( {\{ \vert {S}_{mi} - {S}_{pi} \vert \}}_{i = 1}^{n} )$$

if the minimum difference between measured and predicted sonic is positive. However, if the minimum difference between measured and predicted sonic is negative

$$minD may be - Min ( {\{ \vert {S}_{mi} - {S}_{pi} \vert \}}_{i = 1}^{n} ) .$$

In examples, the amount of correction dynamically changes over time dependent on the statistical significance of the correlation between MSE and sonic data. The initial amount of correction may be zero. Thus, no correction is made for the first sonic prediction. A new correction C_{new} may be calculated based on previous correction C_{old}. For example, a new correction may be calculated when Equation (5) is satisfied:

$$\vert minD - {C}_{old} \vert > C L \qquad ( 5 )$$

where CL is correction limit and defines allowable difference between predicted sonic and measured sonic. It has a default value of 5 μs/m. When Equation (5) is satisfied, new correction C_{new} may be calculated in Equation (6):

$${C}_{new} = \{ \begin{matrix}{C}_{old} + CI & minD > {C}_{old} \\ {C}_{old} - CI & minD < {C}_{old}\end{matrix} \qquad ( 6 )$$

where CI is correction increment and set to a limit of 10% of correction limit CL (i.e., 0.5 μs/m). Sonic prediction after correction S may be update the previously calculated predicted sonic at the bit Sₚ with the new correction C_{new} in Equation (7):

$$S = {S}_{p} + {C}_{new} \qquad ( 7 )$$

In block 710, the correction factor from block 708 may be applied to the correlation from block 706. In examples, this may be performed continuously and/or in real time as MSE, predicted sonic at the bit Sₚ, and new correction C_{new} are updated as logging tool 134 (e.g., referring to FIG. 6) travels downhole and records measurements with transmitters 136 and receivers 137. This may yield a Sonic prediction after correction S log as during a run of logging tool 134.

In block 712, the updated sonic log predicted at the bit may be applied in a geomechanically analysis. For example, information handling system 138 (e.g., referring to FIG. 1) may update borehole collapse. Thus, to maintain a mud pressure higher than the collapse pressure to avoid borehole collapse, information handling system 138 may direct mud pumps and other equipment to maintain stable conditions downhole. In addition, the predicted sonic log may be used to estimate rock mechanical properties, such as rock uniaxial strength. It can be also used to predict formation pore pressure.

The predicted sonic might be used to make decision for other drilling and completion operations. Workflow 700 is a workflow for correlating mechanical specific energy (MSE) with real-time sonic data to determine sonic properties at the bit. In other workflows, sonic log predicted at the bit may be performed without real-time sonic data at the bit measurements. Herein, sonic data at the bit is a sonic measurement of the formation at or around drill bit 122. Sonic data at the bit may be translated to real formation properties conveying the rock type and various properties of formation 106. Workflow 700 is performed with sonic data; however, this sonic data may be replaced with resistivity measurements from logging tool 134 (e.g., referring to FIG. 6). In addition to resistivity measurements, other measurements may also replace sonic measurements. This may comprise any acoustic measurements, electromagnetic measurements, induction measurements, nuclear magnetic resonance measurements, gamma measurements, or any physical or wave particle capable of creating a measurable reflection or effect observable by logging tool 134. These measurements may be performed in real-time.

In examples, if logging tool 134 (e.g., referring to FIG. 1) collects any other downhole measurements or is modified to do so it may then perform blocks 702-712 in the same way, except with other downhole measurements, not sonic data. The workflow may be the same and the measurements may produce the same properties downhole. In other examples, measurements may be utilized to form pseudo-sonic logs. Pseudo-sonic logs may be formed by converting or otherwise predictions of sonic measurements with any other downhole measurement type. This may be in real-time. These pseudo-logs sonic logs may be utilized in workflow 700, just like how the sonic logs are performed.

FIG. 8 illustrates workflow 800 for predicting sonic log at the bit with a correlation between sonic/pseudo-sonic data from offset wells and MSE. Blocks 802 and 804 may follow the same steps as in blocks 702 and 704. In block 806, the same steps and equations apply, except real-time sonic measurements and drilling parameters for MSE calculation are replaced with sonic logs and drilling parameters from an offset well, respectively. In block 808, drilling data in real-time may be collected. Drilling data may comprise all parameters to calculate MSE comprising WOB weight on bit, TOB torque on bit, RPM rotary per minute, ROP rate of penetration, and d bit diameter. It may then compute an updated MSE. In block 810, the correlation from block 806 may be utilized to predict sonic at the bit in real time with the updated MSE from block 808. In examples, data comprising sonic and drilling parameters may be collected from offset wells. The drilling parameters are used to calculate MSE. Then a correlation between the sonic data from offset wells and the calculated MSE from drilling system 100 (e.g., referring to FIG. 1) at the same or similar depths may be formed. This correlation may be formed with equations (3) or (4), as discussed in block 706 (e.g., referring to FIG. 7). During drilling operation, drilling parameters may be collected in real time, and applied to determine MSE. In block 812 the predicted sonic value from block 810 may be recorded in a predicted sonic at bit log. To record a log in block 812, blocks 808 and 810 may be repeated until the whole log is recorded. Finally, in other examples, block 814 may replace blocks 802-806. In block 814, existing correlations between MSE and sonic data from offset wells may be imported. Workflow 800 is performed with sonic data; however, this sonic data may be replaced with resistivity measurements from logging tool 134 (e.g., referring to FIG. 6).

Workflow 800 is performed with sonic data; however, this sonic data may be replaced with resistivity measurements from logging tool 134 (e.g., referring to FIG. 6). In addition to resistivity measurements, other measurements may also replace sonic measurements. This may comprise any acoustic measurements, electromagnetic measurements, induction measurements, nuclear magnetic resonance measurements, gamma measurements, or any physical or wave particle capable of creating a measurable reflection or effect observable by logging tool 134. These measurements may be performed in real-time.

In examples, if logging tool 134 (e.g., referring to FIG. 1) collects any other downhole measurements or is modified to do so it may then perform blocks 802-814 in the same way, except with other downhole measurements, not sonic data. The workflow may be the same and the measurements may produce the same properties downhole. In other examples, measurements may be utilized to form pseudo-sonic logs. Pseudo-sonic logs may be formed by converting or otherwise predictions of sonic measurements with any other downhole measurement type. This may be in real-time. These pseudo-logs sonic logs may be utilized in workflow 700, just like how the sonic logs are performed.

Improvements over current technology allow for predicting sonic data at the bit with a correlation between recorded sonic data not at the bit and MSE. This allows for improved information during drilling operations. In addition, a correlation to predict sonic data at the bit may be created between MSE and sonic data from offset wellbores. Moreover, MSE and sonic data may be correlated in real-time to yield a predicted sonic data log at the bit in real-time.

Statement 1. A method comprising: disposing a logging tool into a borehole, wherein the logging tool comprises: a transmitter configured to transmit a sonic pulse into a borehole; and one or more receivers configured to detect reflected sonic pulses as measured sonic data; collecting one or more drilling parameters from a drilling system; forming a correlation between at least part of the measured sonic data and one measurement from the sonic data and the one or more drilling parameters; and predicting sonic data at a bit with at least the correlation and at the one or more drilling parameters.

Statement 2. The method of statement 1, further comprising computing MSE with the one or more drilling parameters, wherein MSE is mechanical specific energy applied by the drilling system.

Statement 3. The method of statement 2, wherein the one or more drilling parameters compute MSE with:

$$M S E = \frac{4 * W O B}{π * {d}^{2}} + \frac{480 * T O B * R P M}{{d}^{2} + R O P}$$

wherein WOB weight on bit, TOB torque on bit, RPM rotary per minute, ROP rate of penetration, and d bit diameter.

Statement 4. The method of statement 3, wherein the correlation is a power log correlation computed by:

$${S}_{p} = a * M S {E}^{b}$$

wherein Sₚ is predicted sonic at the bit, a is a constant, and b is a power exponent.

Statement 5. The method of statement 3, wherein the correlation is a linear correlation computed by:

$${S}_{p} = m * M S E + n$$

wherein Sₚ is predicted sonic at the bit, m is a slope, and n is a y-intercept.

Statement 6. The method of statement 4, further comprising determining a new correction factor C_{new} if |minD−C_{old}|>CL, wherein the new correction factor C_{new} is C_{old}+Cl if minD>C_{old} or new correction factor C_{new} is C_{old}−Cl if minD<C_{old}, wherein CI is correction increment and set to a limit of 10% of correction limit CL.

Statement 7. The method of statement 6, further comprising updating the predicted sonic at the bit Sₚ with the new correction factor C_{new}, wherein updating the predicted sonic at the bit Sₚ is performed by:

$$S = {S}_{p} + {C}_{new} .$$

Statement 8. The method of statement 3, further comprising computing a new MSE by updating WOB weight on bit, TOB torque on bit, RPM rotary per minute, ROP rate of penetration, and d bit diameter in real time or continuously.

Statement 9. The method of statement 8, further comprising updating the correlation with the new MSE.

Statement 10. The method of statement 1, further comprising updating the correlation with new measured sonic data, wherein the new measured sonic data was not used in the original or a previous computation of correlation.

Statement 11. The method of statement 2, wherein the correlation is formed between sonic logs from an offset well and an MSE from the offset well.

Statement 12. The method of statement 11, further comprising predicting sonic data at the bit with at least the correlation formed between sonic logs from an offset well and an MSE from the offset well and MSE of the drilling system.

Statement 13. A system comprising: a logging tool disposed within a borehole comprising: a downhole transmitter configured to transmit a particle and/or wave into the borehole; a downhole receiver configured to observe a response from the particle and/or wave, wherein the response is a reflection of or an effect of the particle and/or wave within the borehole or within a formation surrounding the borehole; and an information handling system configured to: collect one or more drilling parameters from a drilling system; form a correlation between at least part of the response and the one or more drilling parameters; and predict sonic data at a bit with at least the correlation and at the one or more drilling parameters.

Statement 14. The system of statement 13, wherein the correlation is formed between measurements from an offset well and an MSE from the offset well.

Statement 15. The system of statement 14, further comprising predicting sonic data at the bit with at least the correlation formed between other measurements from an offset well and an MSE from the offset well and MSE of the drilling system.

Statement 16. The system of statement 13, wherein the information handling system is further configured to form at least one pseudo-sonic measurement with the response.

Statement 17. The system of statement 13, wherein the information handling system is further configured to compute MSE with the one or more drilling parameters, wherein MSE is mechanical specific energy applied by the drilling system.

Statement 18. The system, of statement 17, wherein the one or more drilling parameters compute MSE with:

$$M S E = \frac{4 * W O B}{π * {d}^{2}} + \frac{480 * T O B * R P M}{{d}^{2} + R O P}$$

wherein WOB weight on bit, TOB torque on bit, RPM rotary per minute, ROP rate of penetration, and d bit diameter.

Statement 19. The system of statement 18, wherein the information handling system is further configured to compute a new MSE by updating WOB weight on bit, TOB torque on bit, RPM rotary per minute, ROP rate of penetration, and d bit diameter in real time or continuously and update the correlation with the new MSE.

Statement 20. The system of statement 13, wherein the information handling system is further configured to update the correlation with a new response, wherein the new response was not from the response.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method comprising:
disposing a logging tool into a borehole, wherein the logging tool comprises:
a transmitter configured to transmit a sonic pulse into a borehole; and
one or more receivers configured to detect reflected sonic pulses as measured sonic data;
collecting one or more drilling parameters from a drilling system;
forming a correlation between at least part of the measured sonic data and one measurement from the sonic data and the one or more drilling parameters; and
predicting sonic data at a bit with at least the correlation and at the one or more drilling parameters.

2. The method of claim 1, further comprising computing MSE with the one or more drilling parameters, wherein MSE is mechanical specific energy applied by the drilling system.

3. The method of claim 2, wherein the one or more drilling parameters compute MSE with:
$$M S E = \frac{4 * W O B}{π * {d}^{2}} + \frac{480 * T O B * R P M}{{d}^{2} + R O P}$$
wherein WOB weight on bit, TOB torque on bit, RPM rotary per minute, ROP rate of penetration, and d bit diameter.

4. The method of claim 3, wherein the correlation is a power log correlation computed by:
$${S}_{p} = a * M S {E}^{b}$$
wherein Sₚ is predicted sonic at the bit, a is a constant, and b is a power exponent.

5. The method of claim 3, wherein the correlation is a linear correlation computed by:
$${S}_{p} = m * M S E + n$$
wherein Sₚ is predicted sonic at the bit, m is a slope, and n is a y-intercept.

6. The method of claim 4, further comprising determining a new correction factor C_{new} if |minD−C_{old}|>CL, wherein the new correction factor C_{new} is C_{old}+Cl if minD>C_{old} or new correction factor C_{new} is C_{old}−Cl if minD<C_{old}, wherein CI is correction increment and set to a limit of 10% of correction limit CL.

7. The method of claim 6, further comprising updating the predicted sonic at the bit Sₚ with the new correction factor C_{new}, wherein updating the predicted sonic at the bit Sₚ is performed by: S=Sₚ+C_{new}.

8. The method of claim 3, further comprising computing a new MSE by updating WOB weight on bit, TOB torque on bit, RPM rotary per minute, ROP rate of penetration, and d bit diameter in real time or continuously.

9. The method of claim 8, further comprising updating the correlation with the new MSE.

10. The method of claim 1, further comprising updating the correlation with new measured sonic data, wherein the new measured sonic data was not used in the original or a previous computation of correlation.

11. The method of claim 2, wherein the correlation is formed between sonic logs from an offset well and an MSE from the offset well.

12. The method of claim 11, further comprising predicting sonic data at the bit with at least the correlation formed between sonic logs from an offset well and an MSE from the offset well and MSE of the drilling system.

13. A system comprising:
a logging tool disposed within a borehole comprising:
a downhole transmitter configured to transmit a particle and/or wave into the borehole;
a downhole receiver configured to observe a response from the particle and/or wave, wherein the response is a reflection of or an effect of the particle and/or wave within the borehole or within a formation surrounding the borehole; and
an information handling system configured to:
collect one or more drilling parameters from a drilling system;
form a correlation between at least part of the response and the one or more drilling parameters; and
predict sonic data at a bit with at least the correlation and at the one or more drilling parameters.

14. The system of claim 13, wherein the correlation is formed between measurements from an offset well and an MSE from the offset well.

15. The system of claim 14, further comprising predicting sonic data at the bit with at least the correlation formed between other measurements from an offset well and an MSE from the offset well and MSE of the drilling system.

16. The system of claim 13, wherein the information handling system is further configured to form at least one pseudo-sonic measurement with the response.

17. The system of claim 13, wherein the information handling system is further configured to compute MSE with the one or more drilling parameters, wherein MSE is mechanical specific energy applied by the drilling system.

18. The system, of claim 17, wherein the one or more drilling parameters compute MSE with:
$$M S E = \frac{4 * W O B}{π * {d}^{2}} + \frac{480 * T O B * R P M}{{d}^{2} + R O P}$$
wherein WOB weight on bit, TOB torque on bit, RPM rotary per minute, ROP rate of penetration, and d bit diameter.

19. The system of claim 18, wherein the information handling system is further configured to compute a new MSE by updating WOB weight on bit, TOB torque on bit, RPM rotary per minute, ROP rate of penetration, and d bit diameter in real time or continuously and update the correlation with the new MSE.

20. The system of claim 13, wherein the information handling system is further configured to update the correlation with a new response, wherein the new response was not from the response.
